(19) United States
(12) Patent Application Publication
(10) Pub. No.: US 2007/0120839 A1
(43) Pub. Date: May 31, 2007

(54) METHOD FOR DISPLAYING NON-SPECIFIED RESOLUTION FRAME ON PANEL

(76) Inventor: Chien-Chuan Liao, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,821

(22) Filed: Jan. 12, 2006

(30) Foreign Application Priority Data
Nov. 29, 2005 (TW) 94141854

(51) Int. Cl. G09G 5/00

(52) U.S. Cl. 345/213

(57) ABSTRACT

A method for displaying a non-specified resolution frame on a panel is provided. The method is suitable for displaying a frame data whose resolution is not the same as the specified resolution of the panel module on the panel module. The method mainly inserts a dummy pulse into a clock signal in the blanking period, such that the panel module can read the blank data, and the number of the pulses of the clock signal is complied with the resolution of the panel module.

### CROSS-REFERENCE TO RELATED APPLICATION

This application claims the priority benefit of Taiwan application serial no. 94141854, filed on Nov. 29, 2005. All disclosure of the Taiwan application is incorporated herein by reference.

### BACKGROUND OF THE INVENTION

1. Field of the Invention

The present invention relates to a display method for a flat panel display, and more particularly, to a method for displaying a non-specified resolution frame on a panel.

2. Description of the Related Art

Recently, the flat panel display such as the Liquid Crystal Display (LCD) is widely used in our daily life. With the continuous improvement of the semiconductor technique, the LCD panel has advantages of having lower power consumption, higher resolution, higher color saturation, longer lifespan and is thinner and lighter, thus the LCD panel is widely applied in the electronic products such as LCD TV or the LCD screen of the notebook (a.k.a. laptop) computer or the desktop computer.

A flat panel display usually comprises a flat panel module (e.g. an LCD panel module) and a display control apparatus (e.g. a scalar IC). An LCD is exemplified hereinafter for describing the present invention. FIG. 1 schematically shows a block diagram of a conventional LCD circuit. Referring to FIG. 1, the LCD circuit comprises an interface circuit 100, a scalar IC 101, and an LCD panel module 102.

First, the interface circuit 100 converts a frame signal externally input into the LCD (e.g. a DSUB or DVI signal from the computer) to a frame signal that can be accepted by the scalar IC 101 (e.g. performing an analog to digital conversion). Then, the scalar IC 101 modifies the received frame signal. Since the resolution of the received frame signal may be not the same as the specified resolution of the LCD panel module 102 (the LCD panel module usually cannot accept the signal with a non-specified resolution), the resolution of the received frame signal must be modified first, and the modified frame data is then sent to the LCD panel module 102.

In the case where a smaller frame (with the non-specified resolution of the panel module) is intended to be displayed on the LCD panel of the LCD system shown in FIG. 1, for example, the specified resolution of the panel module is 1280×1024, and the user only desires to use a smaller 1024×768 frame rather than use such big frame display area. If the LCD mentioned above is used, the 1024×768 frame is scaled up to fit the 1280×1024 frame, and eventually a full 1280×1024 frame is displayed on the screen.

In order to resolve the problem mentioned above, in a conventional method, besides the scalar IC 101, an additional frame buffer is further added and a blank frame data (e.g. black color) is inserted into the original 1024×768 frame to form a 1280×1024 frame data, which is then sent to the panel module. However, such method inevitably increases the manufacturing cost. In addition to increasing the hardware (memory) cost, it also complicates the layout of the printed circuit board (PCB) and further generates the EMW (Electro Magnetic Wave) interference problem.

### SUMMARY OF THE INVENTION

Therefore, it is an object of the present invention to provide a method for displaying a non-specified resolution frame on a panel. The method is suitable for displaying a frame data whose resolution is not the same as the specified resolution of the panel module.

The present invention provides a method for displaying a non-specified resolution frame on a panel. The method is suitable for displaying a frame data whose resolution is not the same as the specified resolution of the panel module. Wherein, the panel module receives the frame data, a clock signal, a horizontal activation signal, and a vertical activation signal. Here, an activation period of the vertical activation signal is defined as a vertical period, and an activation period of the horizontal activation signal is defined as a horizontal period. The vertical period includes a vertical blanking period, and the horizontal period includes a horizontal blanking period. The method comprises the following steps. First, during the horizontal blanking period, a plurality of pulses is inserted into a clock signal, such that the number of the pulses of the clock signal in the horizontal period is complied with the horizontal resolution of the panel display. Then, during the vertical blanking period, a plurality of pulses is inserted into a horizontal activation signal, such that the number of the pulses of the horizontal activation signal in the vertical period is complied with the vertical resolution of the panel display. Finally, during the horizontal blanking period and the vertical blanking period, a blank frame data is provided to the panel display.

In the present invention, a dummy pulse is inserted into the clock signal, such that the panel module can read the blank data and the number of the pluses of the clock signal is complied with the resolution of the panel module. Accordingly, a frame with lower resolution can be displayed on part of the panel area without having to add additional frame buffer, such that the cost is saved and the conventional problem is resolved.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a block diagram of a conventional LCD circuit.

FIG. 2 schematically shows a flowchart illustrating a method for displaying a non-specified resolution frame on a panel according to a preferred embodiment of the present invention.

FIG. 3 schematically shows a block diagram of a hardware circuit for illustrating a method for displaying a non-specified resolution frame on a panel according to the preferred embodiment of the present invention.

FIGS. 4 and 5 schematically show the timing diagrams illustrating a method for displaying a non-specified resolution frame on a panel according to the preferred embodiment of the present invention.

FIG. 6 schematically shows a displaying result of the method according to the preferred embodiment of the present invention.

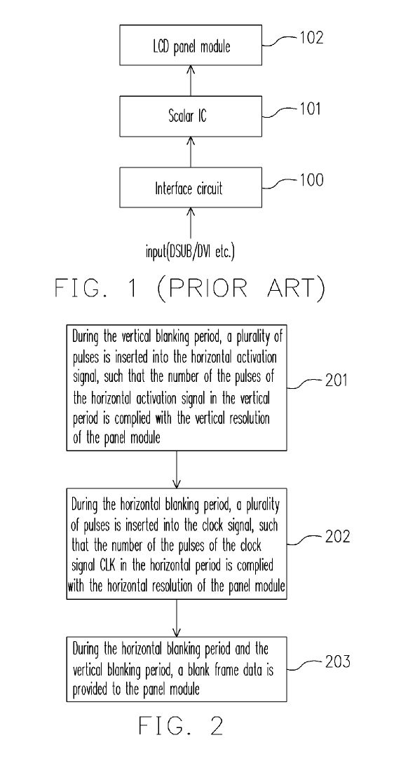

### DESCRIPTION OF THE PREFERRED EMBODIMENTS

An additional frame buffer is required for displaying a frame with lower resolution (i.e. with an non-specified resolution of the panel module) in the conventional method, which inevitably increases the cost, complicates the layout of the printed circuit board (PCB), and further generates the EMW interference problem. Therefore, the present invention provides a method for displaying a non-specified resolution frame on a panel. The method resolves the problems mentioned above without having to add additional frame buffer. The present invention is described in detail with reference to a preferred embodiment of the LCD hereinafter.

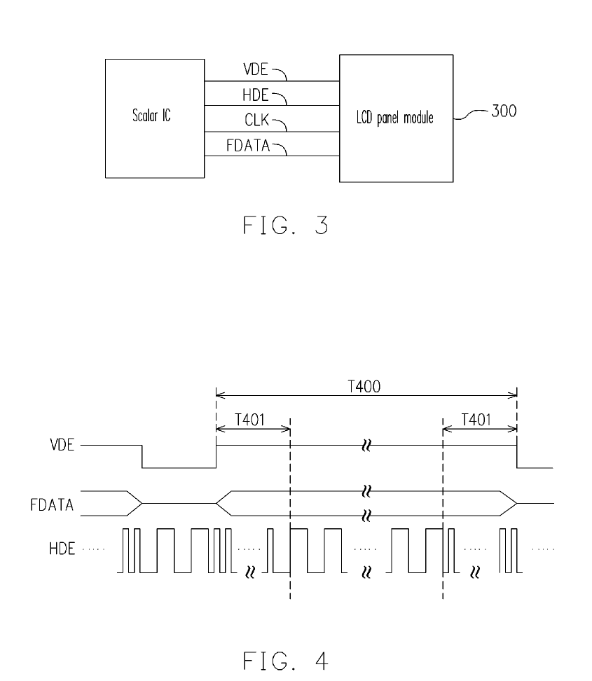

FIG. 2 schematically shows a flowchart illustrating a method for displaying a non-specified resolution frame on a panel according to a preferred embodiment of the present invention. FIG. 3 schematically shows a block diagram of a hardware circuit for illustrating a method for displaying a non-specified resolution frame on a panel according to the preferred embodiment of the present invention. FIGS. 4 and 5 schematically show the timing diagrams illustrating a method for displaying a non-specified resolution frame on a panel according to the preferred embodiment of the present invention. Referring to FIGS. 2, 3, 4 and 5, the method is mainly used to display a frame data FDATA on the panel module 300, wherein the resolution of the frame data FDATA is not the same as the specified resolution of the panel module 300.

Referring to the embodiment of FIG. 3, the LCD panel module 300 receives the frame data FDATA, a clock signal CLK, a horizontal activation signal HDE, and a vertical activation signal VDE. Referring to FIGS. 4 and 5, an activation period T400 of the vertical activation signal VDE is defined as a vertical period T400, and an activation period T500 of the horizontal activation signal HDE is defined as a horizontal period T500. In addition, the vertical period T400 includes a vertical blanking period T401, and the horizontal period T500 includes a horizontal blanking period T501.

It is assumed that the received frame data is a standard signal used by a 1024×768 panel and the specified resolution of the panel module 300 is 1280×1024, and the 1024×768 frame data received by the panel is not necessarily to be the signal provided by the external device such as a computer. It will be apparent to one of the ordinary skills in the art that the external device such as the computer may output a 1280×1024 signal, and after the scaling process of the scalar IC, a 1024×768 signal can be output. Thus, it is obvious that the conventional hardware structure cannot successfully display such frame data.

The method is described in detail referring to the steps of the embodiment in FIG. 2 and the timing diagrams of FIGS. 4 and 5 hereinafter. First, during the vertical blanking period T401, a plurality of pulses is inserted into the horizontal activation signal HDE, such that the number of the pulses of the horizontal activation signal HDE in the vertical period T400 is complied with the vertical resolution of the panel module (step 201). In general, the LCD panel module receives the frame data FDATA according to the horizontal activation signal HDE, and each of the horizontal activation signals HDE represents a horizontal line data. It is assumed that the specified resolution of the LCD panel module is 1280×1024 and the resolution of the frame data is 1024×768. Meanwhile, the panel has to receive at least 1024 pulses of the horizontal activation signal HDE within one line data, thus in order to comply with the vertical resolution of the panel module, at least (1024−768)/2 pulses of the horizontal activation signal HDE within each vertical blanking period T401 must be provided.

Then in step 202, during the horizontal blanking period T501, a plurality of pulses is inserted into the clock signal CLK, such that the number of the pulses of the clock signal CLK in the horizontal period T500 is complied with the horizontal resolution of the panel module. Similarly, it is assumed that the specified resolution of the LCD panel module is 1280×1024 and the resolution of the frame data is 1024×768. During the horizontal period T500, the LCD panel module receives each of the pixel data in the frame data FDATA according to the clock signal CLK. Therefore, originally there should be 1024 pulses of the clock signal in the horizontal period T500 and 2 pulses of clock signal in the horizontal blanking period T501. In the embodiment of the present invention, in order to comply with the horizontal resolution of the panel module, at least (1280−1024)/2 pulses of the clock signal must be added in each horizontal blanking period T501.

Finally, during the horizontal blanking period T501 and the vertical blanking period T401, a blank frame data is provided to the panel module (step 203). Since the data in the horizontal blanking period T501 and the vertical blanking period T401 is the blank data, once the dummy pulse is inserted, the panel module will receive the frame data with reference to the received dummy pulse. Thus, the blank frame data is received and the purpose of complying with the specified resolution of the panel module is achieved.

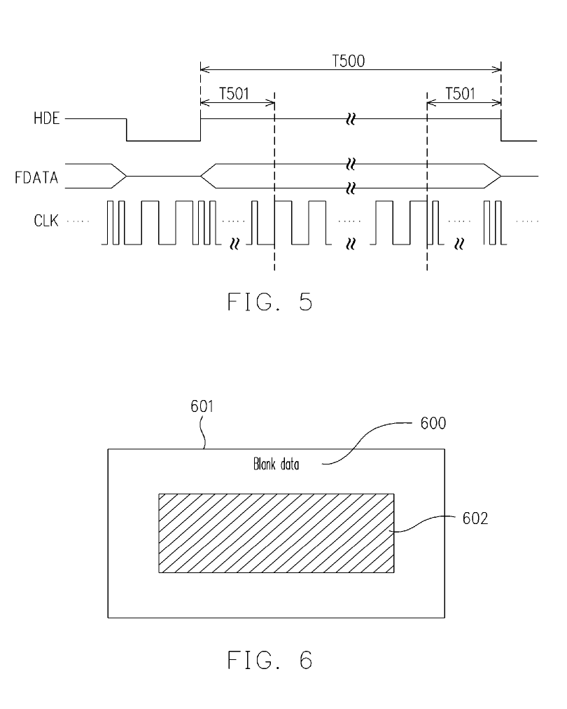

FIG. 6 schematically shows a displaying result of the method according to the preferred embodiment of the present invention. Since a dummy pulse is inserted into the clock signal during the blanking period in the present invention, such that the panel module can read the blank data 600, and the number of the pulses of the clock signal is complied with the resolution of the panel module. Accordingly, a lower resolution frame 602 can be displayed on the panel display area 601 without having to add additional frame buffer, and the purpose of reducing the manufacturing cost is achieved.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A method for displaying a non-specified resolution frame on a panel suitable for displaying a frame data in which the resolution is not the same as a specified resolution of a panel module, wherein the panel module receives the frame data, a clock signal, a horizontal activation signal, and a vertical activation signal, here an activation period of the vertical activation signal is defined as a vertical period, and an activation period of the horizontal activation signal is defined as a horizontal period, moreover, the vertical period includes a vertical blanking period, and the horizontal period includes a horizontal blanking period, the method comprises the following steps:
during the horizontal blanking period, inserting a plurality of pulses into the clock signal, such that the number of the pulses of the clock signal in the horizontal period is complied with a horizontal resolution of the panel display;
during the vertical blanking period, inserting a plurality of pulses into the horizontal activation signal, such that the number of the pulses of the horizontal activation signal in the vertical period is complied with a vertical resolution of the panel display; and
during the horizontal blanking period and the vertical blanking period, a blank frame data is provided to the panel display.

2. The method for displaying the non-specified resolution frame on the panel of claim 1, wherein the step of during the horizontal blanking period, inserting the plurality of pulses into the clock signal, such that the number of the pulses of the clock signal in the horizontal period is complied with the horizontal resolution of the panel module, comprises:
during the horizontal blanking period, the plurality of pulses is inserted by a way of increasing the frequency of the clock signal, such that the number of the pulses of the clock signal in the horizontal period is complied with the horizontal resolution of the panel module.

3. The method for displaying the non-specified resolution frame on the panel of claim 1, wherein the step of during the vertical blanking period, inserting the plurality of pulses into the horizontal activation signal, such that the number of the pulses of the horizontal activation signal in the vertical period is complied with the vertical resolution of the panel module, comprises:
during the vertical blanking period, the plurality of pulses is inserted by a way of increasing the frequency of the horizontal activation signal, such that the number of the pulses of the horizontal activation signal in the vertical period is complied with the vertical resolution of the panel module.

4. The method for displaying the non-specified resolution frame on the panel of claim 1, wherein the panel module comprises an LCD panel module.

5. The method for displaying the non-specified resolution frame on the panel of claim 1, wherein the activation period of the vertical activation signal is a period from a start point where the vertical activation signal is changed from a second state to a first state to an end point where the vertical activation signal is changed from the first state to the second state.

6. The method for displaying the non-specified resolution frame on the panel of claim 1, wherein the activation period of the horizontal activation signal is a period from a start point where the horizontal activation signal is changed from a second state to a first state to an end point where the horizontal activation signal is changed from the first state to the second state.

7. A method for displaying a frame data on a display panel, the frame data has a first resolution and the display panel has a second resolution, the display panel receives the frame data, a clock signal, a horizontal enable signal and a vertical enable signal, activation period of the horizontal enable signal is defined as a horizontal period and activation period of the vertical enable signal is defined as a vertical period, the horizontal period includes a horizontal blanking period, and the vertical period includes a vertical blanking period, the method comprising:
during the horizontal blanking period, inserting at least one pulse into the clock signal, the number of the pulses of the clock signal in the horizontal period is complied with a horizontal resolution of the panel display; and
during the vertical blanking period, inserting at least one pulse into the horizontal enable signal, the number of the pulses of the horizontal enable signal in the vertical period is complied with a vertical resolution of the panel display.

8. The method of claim 7, wherein the first resolution of the frame data and the second resolution of the display panel are different.

9. The method of claim 7 further comprises:
during the horizontal blanking period and the vertical blanking period, providing a blank frame data to the panel display.

10. The method of claim 7, wherein the step of inserting at least one pulse into the clock signal, comprises:
inserting the plurality of pulses by a way of increasing the frequency of the clock signal.

11. The method of claim 7, wherein the step of inserting at least one pulse into the horizontal enable signal, comprises:
inserting the plurality of pulses by a way of increasing the frequency of the horizontal enable signal.

12. The method of claim 7, wherein the activation period of the vertical enable signal is a period from a start point where the vertical enable signal is changed from a second state to a first state to an end point where the vertical enable signal is changed from the first state to the second state.

13. The method of claim 7, wherein the activation period of the horizontal enable signal is a period from a start point where the horizontal enable signal is changed from a second state to a first state to an end point where the horizontal enable signal is changed from the first state to the second state.
